(19) United States
(12) Patent Application Publication
(10) Pub. No.: US 2008/0250456 A1
(43) Pub. Date: Oct. 9, 2008

(54) Method and Apparatus for Optimizing Bandwith in Broadcast/Multicast Video Systems

(76) Inventors: John Alan Gervais, Carmel, IN (US); Mike-Arthur Derrenberger, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 10/586,696

(22) PCT Filed: Feb. 18, 2004
(86) PCT No.: PCT/US2004/004928

§ 371 Date: Jul. 20, 2006

(51) Int. Cl. H04N 5/445

(52) U.S. Cl. 725/54

(57) ABSTRACT

An upstream distribution point of a video distribution system adjusts programming to replace content that is not selected. In particular, an upstream distribution point of a cable broadcast system receives tuning data representing the currently tuned, or selected, program from one or more set-top boxes via Internet Group Management Protocol (IGMP) signaling. The up-stream distribution point collects the tuning data from the one, or more, set-top boxes and replaces at least one of those programs not selected with alternative programming or content.

### BACKGROUND OF THE INVENTION

The present invention generally relates to communications systems and, more particularly, to multi-media communications systems, such as, e.g., a cable broadcast system.

In a multi-media communications system such as, e.g., a cable broadcast system, a cable provider (or system operator) transmits, or broadcasts, video programs (content) to subscribers. This transmission typically takes place from an upstream distribution point, e.g., a cable head-end, over the transmission medium, e.g., cable, to an endpoint, e.g., a set-top box located at a subscriber's home. In such a system, the cable provider may transmit 100 channels, or more, of programming to subscribers—even when no subscribers are watching them. This, in effect, wastes bandwidth that could otherwise be used for additional or new services.

### SUMMARY OF THE INVENTION

Therefore, and in accordance with the principles of the invention, a distribution point adjusts programming to replace content as a function of tuning data received from at least one endpoint.

In an embodiment of the invention, an upstream distribution point of a video distribution system (e.g., a cable broadcast system) receives tuning data representing the currently tuned, or selected, program from one or more endpoints (e.g., set-top boxes). Illustratively, the upstream distribution point receives the tuning data via signaling using a modified IGMP (Internet Group Management Protocol). The upstream distribution point collects the tuning data from the one, or more, endpoints and replaces at least one of those programs not selected with alternative programming or content.

In another embodiment of the invention, an endpoint (e.g., set-top box) sends data as to the currently tuned, or selected, program (tuning data) back to an upstream distribution point of a video distribution system (e.g., a cable broadcast system). In particular, the set-top box uses a modified IGMP to transmit the tuning data to the upstream distribution point.

### BRIEF DESCRIPTION OF THE DRAWINGS

FIG. 1 shows an illustrative video distribution system in accordance with the principles of the invention;

FIG. 2 shows an illustrative flow chart in accordance with the principles of the invention for use in set-top box (STB) 10 of FIG. 1;

FIG. 3 shows an illustrative flow chart in accordance with the principles of the invention for use in head-end 5 of FIG. 1;

FIG. 4 shows an illustrative replaceable program channel list in accordance with the principles of the invention;

FIG. 5 shows another illustrative replaceable program channel list in accordance with the principles of the invention;

FIG. 6 shows an illustrative replaced program channel list in accordance with the principles of the invention;

FIG. 7 shows an illustration of IGMP (Internet Group Management Protocol) message flow;

FIG. 8 shows a modified IGMP packet in accordance with the principles of the invention;

FIG. 9 shows modified IGMP message flow in accordance with the principles of the invention;

FIG. 10 shows another illustrative flow chart in accordance with the principles of the invention for use in STB 10 of FIG. 1; and

FIG. 11 shows an illustrative embodiment of STB 10 of FIG. 1.

### DETAILED DESCRIPTION

Other than the inventive concept, the elements shown in the figures are well known and will not be described in detail. As used herein the terms “multi-media communications system” and “video distribution system” are used interchangeably. Also, familiarity with video distribution systems, such as cable, satellite, terrestrial, etc., is assumed and is not described in detail herein. For example, other than the inventive concept, satellite transponders, cable head-ends, set-top boxes, downlink signals, symbol constellations, predistorters, a radio-frequency (rf) front-end, or receiver section, such as a low noise block, formatting and encoding methods (such as the Moving Picture Expert Group (MPEG)-2 Systems Standard (ISO/IEC 13818-1)) for generating transport bit streams and decoding methods such as log-likelihood ratios, soft-input-soft-output (SISO) decoders, Viterbi decoders and a master program guide (MPG) are well-known and not described herein. In addition, the inventive concept may be implemented using conventional programming techniques, which, as such, will not be described herein. Finally, like-numbers on the figures represent similar elements.

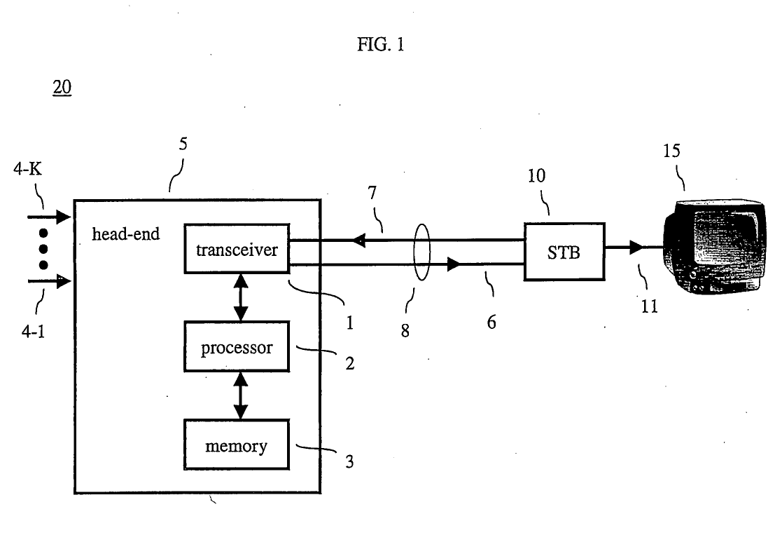

A portion of an illustrative video distribution system 20 in accordance with the principles of the invention is shown in FIG. 1. Video distribution system 20 includes an upstream distribution point 5, a communications channel 8, at least one downstream receiver, or endpoint, as represented by set-top box (STB) 10 and a multi-media endpoint as represented by television (TV) 15. Although described in more detail below, the following is a brief overview of video distribution system 20. Illustratively, video distribution system 20 is a cable broadcast system. In this context, upstream distribution point 5 is, e.g., a cable-head-end 5 (hereafter head-end 5). Head-end 5 is a stored-program-processor based system and includes at least one processor (e.g., a microprocessor) with associated memory as represented by processor 2 and memory 3, along with a transmitter and receiver as represented by transceiver 1. Head-end 5 receives a number of data streams as represented by signals 4-1 through 4-K. Illustratively, each of these K data streams represents a program channel for conveying, e.g., video, audio and/or data. It should be noted that although shown as K separate data streams, head-end 5 may receive one or more data streams that represent aggregations of program channels. Some of the K program channels may represent Pay-Per-View (PPV) and/or Video-on-Demand (VoD) channels and others of the K program channels may represent program channels associated with basic service packages or program channels associated with different pricing structures, e.g., premium service channels. In this regard, head-end 5 distributes the programming to a number of receivers, as represented by STB 10, via communications channel 8, e.g., a coaxial cable, fiber-optic cable, etc. Communications channel 8 supports a downstream channel 6, for conveying program channels (content) from head-end 5 to STB 10, and an upstream channel 7, for conveying data from STB 10 to head-end 5. As known in the art, and other than the inventive concept, the upstream channel is also known as a reverse channel or back channel. Illustratively, the upstream channel and the downstream channel occupy different frequency bands. Turning now to STB 10, STB 10 provides programming to TV 15 via signal path 11. In particular, STB 10 also includes a selector, e.g., a remote control (not shown) that enables a user to select a program for viewing on TV 15. When the user indicates selection of a particular program channel via the remote control, STB 10 tunes to the selected program channel and provides the associated content to TV 15 via signal path 11, for viewing thereon. It should be noted that whether a program channel is a pay-per-view channel and/or a scrambled channel, etc., is irrelevant to the inventive concept.

As noted earlier, some program channels are not selected for viewing by the user. This may result in wasting the associated bandwidth. Therefore, and in accordance with the principles of the invention, a distribution point (e.g., head-end 5) dynamically adjusts programming to replace content as a function of tuning data received from at least one endpoint (e.g., STB 10).

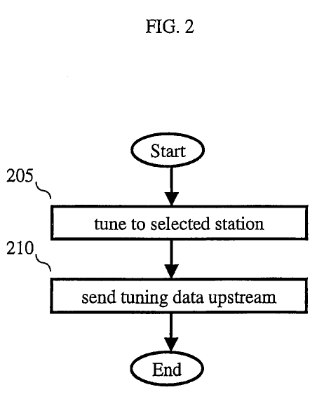

Turning now to FIG. 2, an illustrative flow chart in accordance with the principles of the invention for use in STB 10 is shown. In step 205, STB 10 tunes to a selected program channel, e.g., at power-up, or in response to a user (not shown) selecting one of a number of available program channels via a remote control, etc. In step 210, STB 10 sends information (tuning data) relating to the selected program channel upstream to head-end 5. While the tuning data can take any form that identifies the selected program channel, it is assumed herein that the tuning data includes the associated downstream frequency in MHz (millions of hertz) for the selected program channel, along with the associated packet identifier (PID) for the content (video, audio, data, etc.) of the selected program channel. Both the downstream frequency and PID data are available from, e.g., a master program guide (MPG) stored in STB 10. Illustratively, step 210 can be performed every time the user selects a channel or, e.g., after STB 10 has been tuned to the selected program channel for a predetermined amount of time, e.g., five minutes. For example, STB 10 can notify head-end 5 each time the user changes channels. It should also be noted that, equivalently, STB 10 may periodically, or a periodically, send information with respect to program channels that are not currently selected or, e.g., have not been selected for a predetermined amount of time.

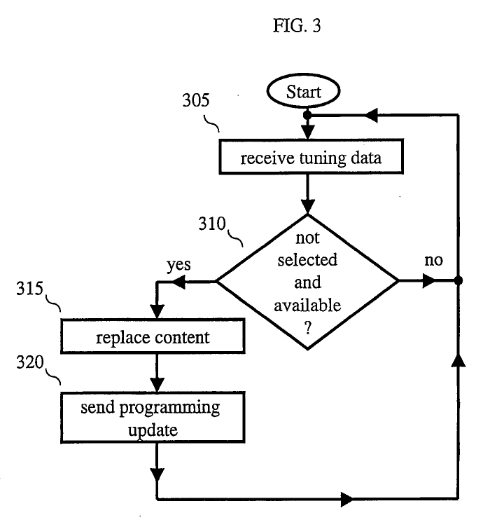

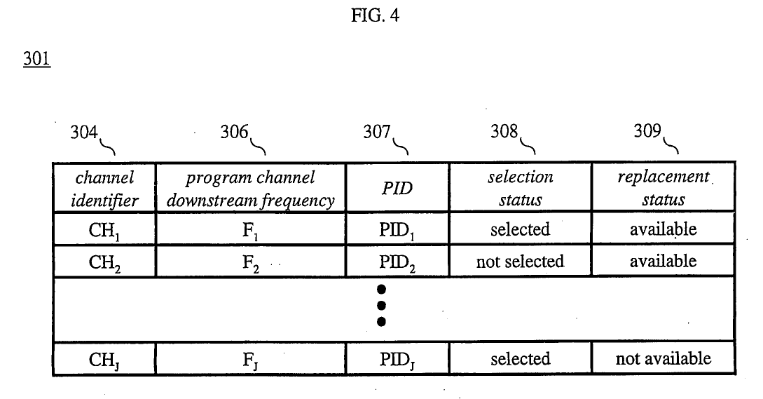

Referring now to FIG. 3, an illustrative flow chart in accordance with the principles of the invention for use in head-end 5 is shown for processing the tuning data received from STB 10 and other STBs (not shown). In step 305, head-end 5 receives the tuning data from the STBs, such as STB 10, via transceiver 1 of FIG. 1. For the purposes of this description, it is assumed that head-end 5 maintains, or stores, a “replaceable program channel” list of J program channels, where J≧1 and J is ≦K, in memory (e.g., in memory 3 of FIG. 1). This replaceable program channel list indicates those program channels that are replaceable and may include all of the available program channels in video distribution system 20, i.e., J=K, or may be as small as a single program channel, i.e., J=1, etc. For example, if video distribution system 20 offers 105 program channels, four of these program channels may be replaceable and, as such, listed on the replaceable program channel list. Further, these J program channels themselves may be priced differently than program channels that are continuously available. An illustrative replaceable program channel list 301 is shown in FIG. 4. Replaceable program channel list 301 includes J rows, each row associated with a particular one of the J program channels. For each program channel, respective values for the associated channel identifier field 304, program channel downstream frequency field 306, packet identifier (PID) field 307, selection status field 308 and replacement status field 309 are listed. The channel identifier (e.g., channel 2), program channel downstream frequency and PID values are predefined, e.g., in a master program guide (MPG) available to head-end 5. The selection status field 308 represents whether or not the associated program channel is currently selected by at least one STB, illustrative values are “selected” or “not selected.” The replacement status field 309 represents whether or not the associated program channel is “available” for replacement, “not available” for replacement, or if the associated program channel has already been “replaced.” As can be observed from replaceable program channel list 301, illustratively the last program channel entry, F_{J}, is not available for replacement even if no STBs select this channel. Alternatively, program channels not available for replacement may simply not be listed on the replaceable program channel list. As tuning data is received in step 305 of FIG. 3, head-end 5 updates replaceable program channel list 301 to indicate which of the J program channels are currently selected by an STB and which are not currently selected by an STB. In step 310 of FIG. 3, head-end 5 checks replaceable program channel list 301 to determine if any of the J program channels are not selected by the STBs of video distribution system 20 and, if not selected, if they are available for replacement (replacement status 309). (As noted above, this additional “available” qualifier is not necessary if, e.g., the above-noted “not available” replacement status is not used in replaceable program channel list 301.) This step can be performed periodically or a periodically. If all of the J program channels of replaceable program channel list 301 are marked as selected or, if unselected, not available for replacement, head-end 5 continues to receive tuning data in step 305. However, if one, or more, of the J program channels are not selected and available for replacement, head-end 5 replaces content in step 315 for these one, or more, J program channels. It should be noted that any number of “thresholds” may be used before head-end 5 replaces content. For example, head-end 5 may periodically check replaceable program channel list 301 every five minutes and only replace content for a particular program channel on replaceable program channel list 301 if that channel has been marked as “not selected” for, e.g., thirty continuous minutes. Similarly, statistical data may be accumulated by head-end 5 for use in determining when to replace content for a particular program channel.

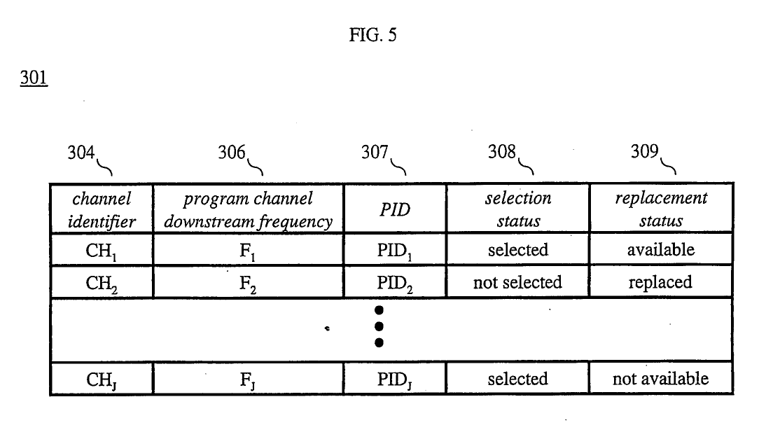

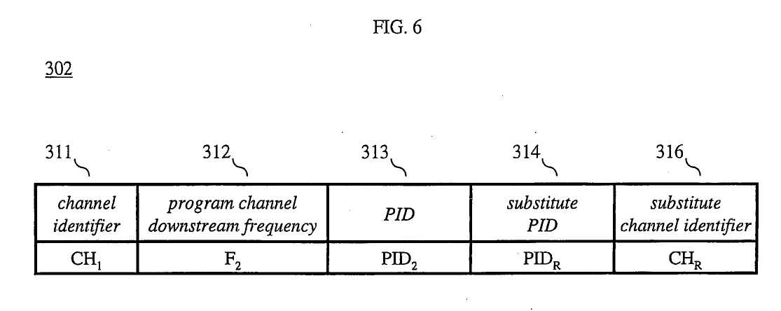

In this illustration, and as can be observed from FIG. 4, the program channel associated with CH₂, F₂ and PID₂, has not been selected by an STB of video distribution system 20 and is available for replacement. As such, in step 315 head-end 5 replaces the content for the identified program channel. First, head-end 5 updates replaceable program channel list 301 as shown in FIG. 5 to indicate that the program channel associated with CH₂, F₂ and PID₂, has been replaced by changing the “available” entry to a “replaced” entry. Then, head-end 5 updates a replacement program channel map that associates (or links, etc.) the removed program channel, CH₂, F₂, PID₂, with the replacement program channel. An illustrative replacement program channel map 302 is shown in FIG. 6. Replacement program channel map 302 includes a number of rows, one row for each program channel that is being replaced. Illustratively, replacement program channel map 302 only shows one row. Each row comprises channel identifier field 311, program channel downstream frequency field 312, PID field 313, substitute PID field 314 and substitute channel identifier field 316. The channel identifier field 311, program channel downstream frequency field 312 and PID field 313 are defined in similar fashion to channel identifier field 304, downstream frequency field 306 and PID field 307, respectively, for the replaced program channel. Substitute PID field 314 stores the value of the new packet identifiers associated with the replacement content for the program channel, while substitute channel identifier field 316 stores the value for the channel associated with the replacement content. It should be noted that the replacement content may use the same channel number as indicated by the value of channel identifier field 311. The replacement content is now provided at the program channel downstream frequency of F₂ and has a PID value of PID_{R}. For the purposes of this description, it is assumed that the PID value and channel identifier value for the replacement content is predefined (e.g., available in a version of an MPG (not shown) stored in head-end 5). It should be noted that various mechanisms for determining the replacement content can be used. For example, replacement content may be selected from a prioritized list of replacement content that may further be a function of the time-of-day, date, etc.; a rotating list of replacement content; etc. Although the replacement content may be, e.g., a movie, the replacement content may also be, e.g., an infomercial.

Once the replacement (or new) content has replaced the unselected (or old) content, head-end 5 performs step 320. In particular, head-end 5 sends update data for the MPG, e.g., a new MPG, associating the PD value for the replacement content, PID_{R}, with the downstream frequency channel, F₂, to the STBs, e.g., STB 10. This new MPG may also include additional programming information associated with the replacement content, e.g., the new channel identifier, CH_{R}, to associate with the new content. In addition, head-end 5 begins transmission of the replacement content to the STBs at the associated downstream frequency channel, F₂. Thus, head-end 5 can replace the old content with other revenue producing content such as Pay Per View, Video on Demand, an infomercial, etc. In this regard, the inventive concept can be viewed as replacing the old content with new content or as increasing the bandwidth allocated to other content or services. For example, increasing a bandwidth allocation of a PPV service by using at least a portion of the bandwidth associated with the replaced content for the PPV service. After step 320, execution returns to receiving tuning data in step 305.

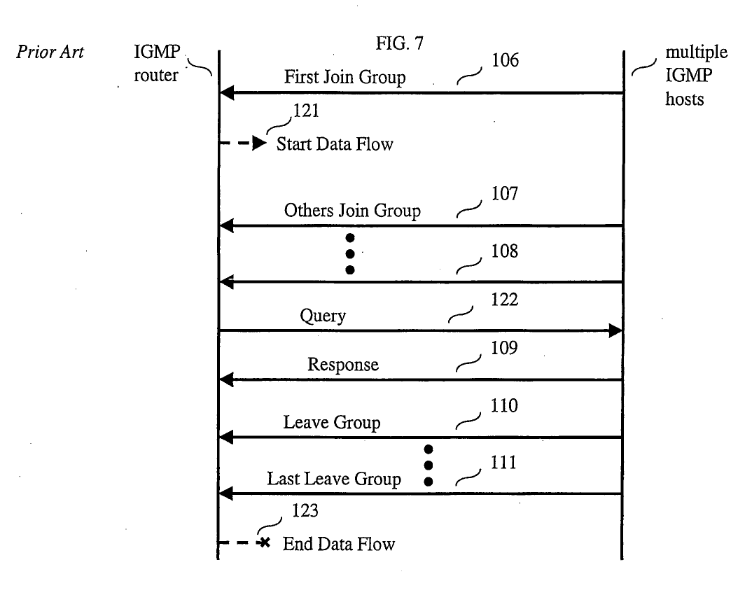

As noted above, STB 10 provides tuning data via the upstream channel to head-end 5. Illustratively, and in accordance with the principles of the invention, STB 10 uses a modified form of the Internet Group Management Protocol (IGMP) for signaling head-end 5 as to the currently selected program channel. Other than the inventive concept, the IGMP protocol is well-known and not described in detail herein. The IGMP protocol allows internet hosts to participate in multicasting and is defined in RFC (Request for Comment) 1112 and RFC 2236. A typical message flow in accordance with the IGMP protocol is shown in FIG. 7 between an IGMP router and multiple IGMP hosts (individually not shown). For example, a first IGMP host (not shown) sends a “join group” message 106 to the IGMP router for joining a particular multicast group. Since this is the first host to request to join the particular multicast group (hence the “first join group” message 106), the IGMP router begins transmission of the multicast as represented by start data flow 121. Subsequently other IGMP hosts may also request to “join” the particular multicast group as represented by join group messages 107 and 108. Further, IGMP supports query (122) and response (109) messages between the IGMP router and individual ones of the IGMP hosts. Finally, IGMP hosts may eventually end receipt of the multicast by sending a “leave group” message as represented by leave group messages 110 and 111. When the last leave group message is received as represented by “last leave group” message 111, the IGMP router ends the multicast transmission as represented by end data flow 123.

The IGMP protocol can be divided into two distinct portions. The upper portion of the protocol consists of well-defined messaging between a host and a multicast router and the associated membership state machines. The lower portion is tied to the IP (Internet Protocol) addressing and packet forwarding schemes. In accordance with a feature of the invention, this lower portion is discarded and the upper IGMP protocol is used to manage any type of non-IP multicast network such as the representative cable network of FIG. 1. Illustratively, head-end 5 incorporates the characteristics of the above-described IGMP router while each STB acts as an IGMP host. The above described, join, leave, query and response packets of the IGMP protocol are illustratively exchanged via communications channel 8.

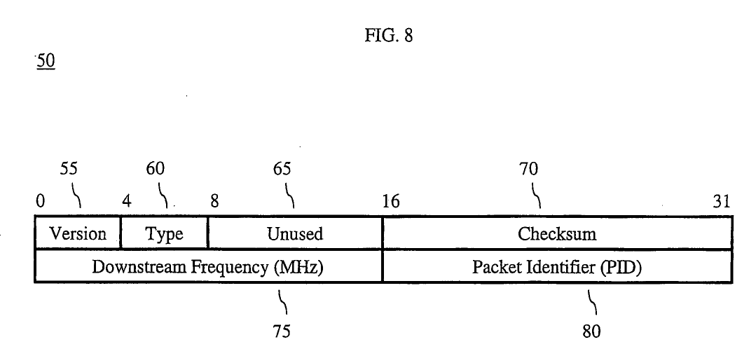

An illustration of a modified IGMP packet format is shown in FIG. 8. IGMP packet 50 includes a number of fields: version field 55, type field 60, unused field 65, checksum field 70, downstream frequency field 75 and packet identifier (PID) field 80. The illustrative format of IGMP packet 50 is based on IGMP version 1. It should be noted that other versions of IGMP can be modified in a similar fashion. The version field 55, type field 60, unused field 65 and checksum field 70 are as defined in the above-mentioned RFCs. The version field 55 is a four bit field that stores version information and is illustratively set equal to a binary value of one. The type field 60 is also a four bit field and specifies the IGMP type and is illustratively set to a binary value of one. The unused field 65 is an eight bit unused field, the checksum field 70 is a sixteen bit checksum over the IGMP packet.

In accordance with the principles of the invention, the structure of the IGMP packet format is preserved with the thirty-two bit group address field (not shown) now replaced by downstream frequency field 75 and packet identifier field 80. The downstream frequency field 75 and the packet identifier field 80 represent the relevant parameters of a program channel. Thus, a program channel, in effect, is treated like a multicast group to which any STBs can join or leave. In accordance with the principles of the invention, the downstream frequency field 75 is a 16 bit value representing the frequency in MHz (millions of hertz) of the currently selected program channel and the packet identifier field 80 is also a sixteen bit field representing the PID value for the selected program channel. Both the value of the downstream frequency field and the PID for the selected program channel are available from, e.g., a master program guide (not shown) previously transmitted, or downloaded, to, e.g., STB 10 by head-end 5. It should be noted that other variations of an IGMP protocol are also possible. For example, and in accordance with the principles of the invention, a new type can also be defined, e.g., a type 6 (binary value of 6) associated with the transmission of tuning data in an IGMP packet.

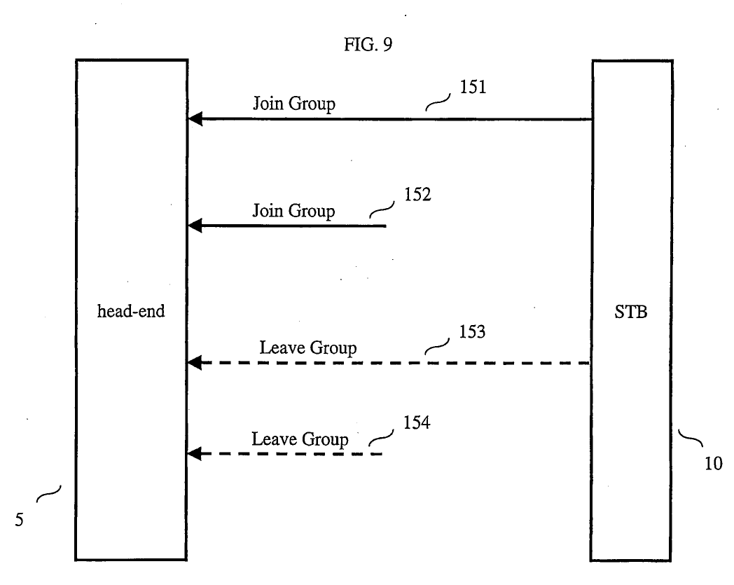

Referring now to FIG. 9, an illustrative message flow in accordance with the principles of the invention is shown between head-end 5 and STB 10. As noted above, in the context of the invention, each program channel is treated as if it were a multicast group, i.e., a program channel group. As such, when STB 10 is tuned to a selected program, STB 10 sends a respective “join group” message 151 to head-end 5, i.e., STB 10 joins a group of STBs currently tuned to that program channel. The join group message 151 includes the down stream frequency and the PID for the program channel that STB 10 is currently tuned to receive. Other STBs (not shown) may also join this same program channel group or other program channel groups as represented by join group message 152. Thus, head-end 5 tracks those program channels that are currently being selected by STBs, e.g., using the flow chart illustrated in FIG. 3. In this context, head-end 5 uses join group message 151 to continually update the currently tuned program for the respective STB versus the use of a leave group message.

Conversely, although not required, STB 10 may leave a program channel group by sending a leave group message 153, where, again, the leave group message identifies the down stream frequency and associated PID of the program channel that STB 10 is no longer tuned to receive. This optional operation is shown in dashed-line form in FIG. 9. Similarly, other STBs (not shown) may also leave this same program channel group or another program channel group as represented by leave group message 154. It should be observed that in the context of a message flow, once a “leave group message” is sent from an STB to the head-end, that STB will likely shortly follow with a “join group message” since an STB is typically always tuned to at least one program channel. However, this is not required. For example, an STB may not be required to send a “join group message” when the STB tunes to a program channel associated with a electronic program guide, or an STB may not send a “join group message” unless the STB is tuned to a program channel for at least a predefined amount of time (e.g., the above-noted five minutes).

As described above, head-end 5 may replace the content of a particular program channel with new content under certain conditions, e.g., if all of the STBs of video distribution system 20 have indicated that the particular program channel is unselected. Thus, unused program channels may be replaced with alternative programming content in an attempt to attract viewers.

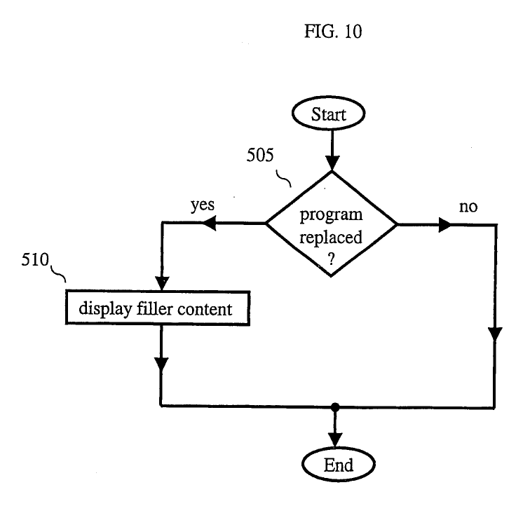

As noted above, the new content may, or may not use the same channel number as the old content. However, as described herein it is illustratively assumed that the channel number associated with the replaced content is still available for selection by the user, i.e., the user expects to see the old content upon selection of the old channel number. As such, when a user selects the channel number of the replaced content, e.g., during transient channel surfing, STB 10 provides “filler content” notifying, or alerting, the user that the selected channel is currently unavailable. This is illustrated in the flow chart of FIG. 10. After tuning to a selected program channel, STB 10 checks if the selected program channel has been replaced in step 505. Such an indication may exist in a new MPG (noted above) provided by head-end 5. If the selected program channel has not been replaced, execution ends. However, if the selected program channel has been replaced, STB 10 displays the filler content in step 510. This filler content (not shown) may be a generic “unavailable” graphic, an associated channel logo or other suitable graphic. This filler content may be downloaded to STB 10 via, e.g., the above-noted new MPG provided from head-end 5. It should also be noted that that filler content may also take other forms, e.g., a low bit rate video of the replaced content may be provided to the user. This low bit rate video may either be stored in STB 10 or provided from head-end 5 on another program channel that, e.g., multiplexes a number of low-bit rate channels. In this latter case, the mapping of the low bit rate video is included within the new MPG, e.g., the replaced channel identifier is associated with a particular PID value conveyed over another downstream frequency channel.

In terms of restoration of replaced content, any one of a number of approaches may be used. For example, head-end 5 may restore all replaced content at a particular time of day, e.g., in the middle of the night; or, head-end 5 may simply rotate the new content to other program channels that are subsequently tagged as unselected and then restore the previously replaced content. As another alternative, when head-end 5 receives tuning data from at least a predefined number of STBs indicating selection of a program channel that has already been replaced, head-end 5 terminates the transmission of the new content and restores the old content. This restoration can even be gradual, starting with a low-bit rate video of the replaced content and gradually increasing to a high-bit rate video of the replaced content.

As described above, the inventive concept allows an operator of a video distribution system to, in effect, over subscribe their bandwidth such that at some point in time they will be able to recover bandwidth from unwatched programs. In addition, it should be noted that the data about the number of viewers watching a given program at a given time may be valuable and, as such, may also be marketable as a service or product to content providers. It may also be of value to organizations such as those engaged in a Nielsen-type rating service.

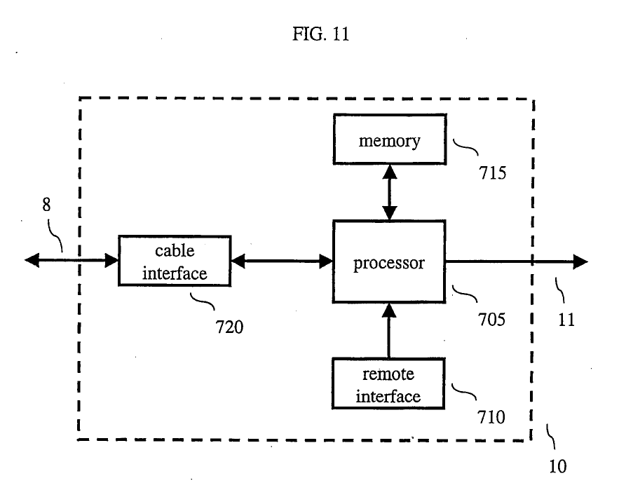

Turning now to FIG. 11, an illustrative embodiment of STB 10 is shown. It should be noted that only those elements of STB 10 relevant to the principles of the invention are shown. STB 10 comprises a communications interface, e.g., cable interface 720, for coupling to communications channel 8, at least one processor as represented by processor 705, a memory 715 and a remote interface 710, which receives the earlier mentioned program channel selection from a remote control device (not shown) operated by a user. Processor 705 is representative of a stored-program processor, e.g., a microprocessor, that executes a program, or programs, (such as represented by the above-described flow charts of FIGS. 2 and 10) stored in memory 715, which may be internal and/or external to processor 705 and is volatile and/or non-volatile, as necessary. As can be observed from FIG. 11, processor 705 receives signals from the cable interface 720 and provides signals, e.g., content, via signal path 11.

It should also be noted that although described in the context of a cable-based video system, the inventive concept is not so limited and applies to terrestrial broadcast, satellite broadcast, etc. Also, although the return, or uplink, channel was illustrated as a part of the same communications medium as the downstream channel, this is not required and, e.g., the upstream channel may be of a different type and/or at a different physical location from the downstream channel. For example, the downstream channel can be a conveyed over a coaxial cable, while the upstream channel is conveyed over a dial-up telephone connection (wired or wireless) via the public switched telephone network (PSTN). In addition, although the inventive concept was described in the context of replacing content that is not being viewed, content may also be replaced as a function of the received tuning data if, e.g., the number of viewers is less than a predetermined amount. Further, it should also be noted that groupings of components for particular elements described and shown herein are merely illustrative. For example, head-end 5 may be located further upstream in a distribution system such that other distribution points, or routers, are located between head-end 5 and STB 10. Also, although described in the context of video programming, it should be realized that the inventive concept applies to programming be it video, audio and/or data (e.g., executable code). In this regard, the term “program” may also encompass video, audio and/or data and the term “viewed” simply refers to the currently tuned program of the receiver regardless of whether the program represents video, audio and/or data.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements may be implemented in a stored-program-controlled processor, e.g., a digital signal processor (DSP) or microprocessor that executes associated software, e.g., corresponding to one or more of the steps shown in FIGS. 2, 3 and 10. Further, although shown as separate elements, the elements therein may be distributed in different units in any combination thereof. For example, STB 10 may be a part of TV 15. It is therefore to be understood that numerous modifications may be made to the illustrative embodiments and that other arrangements may be devised without departing from the spirit and scope of the present invention as defined by the appended claims.

1. A method for use in an upstream endpoint of a video distribution system, the method comprising:
receiving tuning data from at-least-one endpoint of the video distribution system, the tuning data representing programming that is currently being viewed at the at-least-one endpoint; and
adjusting programming to replace content as a function of the received tuning data;
wherein the tuning data is received via a modified form of IGMP (Internet Group Management Protocol) signaling and wherein the modified form of IGMP signaling includes a packet comprising downstream frequency information and packet identifier information representing the programming that is currently being viewed.

2. The method of claim 1, wherein the adjusting step replaces content that is not being viewed.

3. The method of claim 1, wherein the currently viewed programming is a video program.

4. The method of claim 1, wherein the video distribution system is a cable broadcast system.

5. The method of claim 1, wherein the adjusting step includes the steps of:
determining from the received tuning data at-least-one program that is not being viewed;
disabling the transmission of the at-least-one program, the at-least-one program having associated therewith a first bandwidth; and
increasing a bandwidth allocation of another service of the video distribution system by using at least a portion of the first bandwidth.

6. A method for use in an upstream endpoint of a video distribution system, the method comprising:
receiving tuning data from at-least-one endpoint of the video distribution system, the tuning data representing programming that is currently being viewed at the at-least-one endpoint; and
adjusting programming to replace content as a function of the received tuning data;
wherein the adjusting step includes the steps of
determining from the received tuning data at-least-one program that is not being viewed;
checking if the at-least-one program that is not being viewed is available for replacement before performing the replacing step; and
if the at-least-one program that is not being viewed is available for replacement, replacing the at-least-one program that is not being viewed with another program.

7. A method for use in an endpoint of a video distribution system, the method comprising:
determining programming that is currently being viewed; and
sending tuning data representing the currently viewed programming to an upstream distribution point;
wherein the sending step includes the step of sending the tuning data via IGMP (Internet Group Management Protocol) signaling and wherein the IGMP signaling includes a packet comprising information representing the currently viewed programming.

8. The method of claim 7, wherein the video distribution system is a cable broadcast system.

9. The method of claim 7, wherein the endpoint is a set-top box.

10. The method of claim 7, wherein the step of determining includes:
receiving a channel selection from a user; and
tuning to the selected channel for providing the programming to the user.

11. A method for use in an endpoint of a video distribution system, the method comprising:
receiving a channel selection from a user;
determining if the selected channel is associated with replaced programming; and
if the selected channel is associated with replaced programming, providing filler content for display to the user instead of the replaced programming.

12. A method for providing a video broadcast service to a number of users, comprising:
identifying at least one program channel as a replaceable program channel; and
providing the replaceable program channel to the number of users, wherein the replaceable program channel may at times be replaced by content from another program channel as a function of the number of users that select the replaceable program channel.

13. The method of claim 12, wherein the replaceable program channel is replaced if the replaceable program channel is not selected by any of the number of users.

14. Apparatus for use in an upstream distribution point of a multi-media communications system, the apparatus comprising:
a receiver for receiving tuning data from at least one downstream endpoint of the multi-media communications system; and
a processor operative on the received tuning data for replacing content of a program channel that is not being viewed with new content;
wherein the tuning data is received via a modified form of IGMP (Internet Group Management Protocol) signaling and wherein the modified form of IGMP signaling includes a packet comprising downstream frequency information and packet identifier information representing the programming that is currently being viewed.

15. The apparatus of claim 14, further including a memory for storing a replaceable program channel list comprising a list of program channels and a respective current selection status, wherein the processor updates the current selection status in accordance with the received tuning data.

16. The apparatus of claim 15, wherein the processor checks the current selection status of the replaceable program channel list to determine if a program channel is not being viewed.

17. The apparatus of claim 14, wherein the upstream distribution point is a cable head-end.

18. The apparatus of claim 14, wherein the multi-media communications system is a cable broadcast system.

19. Apparatus for use in an endpoint of a video distribution system, the apparatus comprising:
a communications interface for coupling to a communications channel; and
a processor for determining programming that is currently being viewed, and for sending tuning data representing the currently viewed programming via the communications interface for transmission over the communications channel to an upstream distribution point;
wherein the processor causes the tuning data to be sent using IGMP (Internet Group Management Protocol) signaling and wherein the IGMP signaling includes a packet comprising information representing the currently viewed programming.

20. The apparatus of claim 19, wherein the communications channel is a public-switched-telephone-network (PSTN).

21. The apparatus of claim 19, wherein the communications channel is a part of a cable broadcast system.

22. The apparatus of claim 19, wherein the endpoint is a set-top box.

23. The apparatus of claim 19, further comprising a remote interface for receiving a program channel selection from a user and for providing the program channel selection to the processor for use in determining the programming that is currently being viewed.

24. Apparatus for use in an endpoint of a video distribution system, the apparatus comprising:
a communications interface for coupling to a communications channel; and
a processor for determining if a program channel selection from a user is associated with replaced programming; and, if so, for providing filler content for display to the user instead of the replaced programming.
